(19) United States
(12) Patent Application Publication
(10) Pub. No.: US 2012/0048880 A1
(43) Pub. Date: Mar. 1, 2012

(54) METHOD AND APPARATUS FOR DISPENSING HAIR DYE PRODUCTS

(76) Inventor: Chris Damolaris, Naperville, IL (US)

(21) Appl. No.: 12/862,486

(22) Filed: Aug. 24, 2010

(51) Int. Cl. B67D 7/00; B67D 7/08

(52) U.S. Cl. 222/1; 222/25; 222/52

(57) ABSTRACT

A dispensing apparatus for dispensing hair products such as developer solution. The dispensing apparatus includes a user interface for interacting with the user by allowing the user to enter desired parameters or for displaying prompts to the user. The user interface also includes a user tracking mechanism such as a card reader or a key pad where identifying information can be communicated to the apparatus. Data pertaining to each dispensing transaction is processed by the controller and communicated to a database, wherein the information is stored for retrieval at a later time. User data can be used by the business owner to manage his business more efficiently. The user may enter the desired dispensing parameters which are communicated to the dispensing mechanism. A reservoir containing developer solution is connected to a pump which, in conjunction with a central controller, regulates the dispensing of developer solution.

### FIELD OF THE INVENTION

This invention relates in general to the dispensing of hair dye or developer related products.

### BACKGROUND OF THE INVENTION

Many people desiring to change their hair color opt to avail themselves to the services provided by a hair salon. The customer selects the desired hair color, and a professionally trained hair colorists attempts to recreate the selected color. Typically, a trained colorist is able to predict the final color of the hair treatment based on experience with numerous types of dye products and hair types. The final outcome of the hair dye treatment depends on a variety of factors, including the ability of the dye to retain color, the amount of developer used, and the color of the user's hair.

Hair dye manufacturers make numerous lines of products, with each line of products containing up to a hundred different colors. Typically, a developer solution is used to cause the dye to couple inside the hair structure to form molecules to provide hair with the desired color. The developer is usually mixed with the dye at 2:1 or 1:1 ratios, depending on the desired results. The hair colorist mixes the developer with the dye, and applies the mixture to the consumer's hair.

Developer solution contains an oxidizing agent, usually hydrogen peroxide. Deterioration of the developer solution occurs with exposure to oxygen. Thus, an unfinished bottle of developer solution typically goes to waste after prolonged exposure to air. Containers for preventing the exposure of hair dye products to oxygen are present in prior art systems. U.S. Pat. No. 5,855,626 discloses a system for mixing and dispensing oxygen sensitive hair dye consisting of concentrates in a sealed air-tight system using preferably 3-8 dye concentrates in collapsible bags having an oxygen barrier.

Because the amount of developer solution and hair dye have to be mixed carefully to arrive at the right result, it is desirable to have a system where a specific amount is pumped out. This is also desirable to provide consistency between customer visits. Prior art products for dispensing fluid in a predetermined quantity is disclosed in U.S. Pat. No. 7,3567,473.

Current systems allow for developer solution to be dispensed and used without the ability to account for the amount a user consumes. A colorist may open a new container of developer solution and use as much as needed for a client. The remaining developer solution is either discarded or has oxidized to some degree before it is used up. Further, oxidized developer negatively effects resultant hair color. Because current systems do not track an individual user's consumption of developer solution, it is difficult for a salon owner to ensure that wasteful usage of developer solution is minimized. Having a tracking system for developer products assists to minimize waste and allows the amount used by a colorist to be attributed individually, and encourages the user to pay more attention to charging clients for the appropriate amount of developer solution used. A salon owner can also have the option to use a fee sharing arrangement that more closely reflects the proportional use of developer solution or other liquid hair treatment product by each individual.

The present inventor has recognized the need for a system for dispensing hair products which allows the amount dispensed to be attributed to the usage of individual users.

The present inventor has recognized the need for a system for dispensing hair products which is easy to use and can be configured to meet various dispensing needs.

The present inventor has recognized the need for a system for dispensing hair products which allows for more efficient use of hair product and thus minimizes waste. Minimizing the waste disposal of excess developer assists in reducing environmental damage otherwise caused by the disposal of excess developer down the drain.

The present inventor has recognized the need for a system for dispensing hair products which encourages the user to more carefully adjust client costs in proportion to the actual amount of hair products used on the client.

### SUMMARY OF THE INVENTION

The invention provides a dispensing apparatus for the dispensing of hair products, such as developer solution. The dispensing apparatus comprises a user interface, a pumping station, and a dispensing station. The user interface allows for the user to communicate with the dispensing apparatus to achieve the desired result. The user interface comprises a display screen for communicating with the user by displaying prompts and other displays for interacting with the user. The user interface also comprises a user tracking mechanism which allows the identity of the user to be correlated with each dispensing transaction.

Data pertaining to each dispensing transaction is processed by the controller and communicated to a database, wherein the information is stored for retrieval at a later time. Analysis of user data allows the company or business owner to view patterns in developer use, and can be used by the company or business owner to manage his business more efficiently. Meanwhile, the user's desired dispensing parameters are also communicated to a dispensing mechanism, which is in communication with a pumping mechanism.

The dispensing mechanism comprises a compartment suitable for receiving an airtight reservoir or container of developer solution. Developer solution is disposed within the compartment and a port is used to connect the contents of the reservoir to an inlet end of the pump. The pump regulates the dispensing of the developer solution by allowing a controlled flow of developer solution to exit the pump at the outlet end of the pump. The outlet end of the pump is connected to a dispensing nozzle. Developer exiting the dispensing nozzle is dispensed to the user.

The dispensing apparatus can further comprise a sensor which signals to the user when the level of developer solution within the compartment has fallen below a per-determined level.

Numerous other advantages and features of the present invention will become readily apparent from the following detailed description of the invention and the embodiments thereof, from the claims, and from the accompanying drawings.

### BRIEF DESCRIPTION OF THE DRAWINGS

FIG. 1 is a front view of one exemplary embodiment of the dispensing apparatus.

FIG. 2 illustrates one exemplary embodiment of the user interface.

FIG. 3 is a schematic diagram of one embodiment of the communication signal pathways of the dispensing apparatus.

FIG. 4 is a schematic diagram illustrating a database of data fields.

FIG. 5 is a top view of the apparatus of FIG. 1.

FIG. 6 is a side view of the apparatus of FIG. 1.

FIG. 7 is a schematic diagram illustrating the logic step of one embodiment of the processing of the dispensing apparatus.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

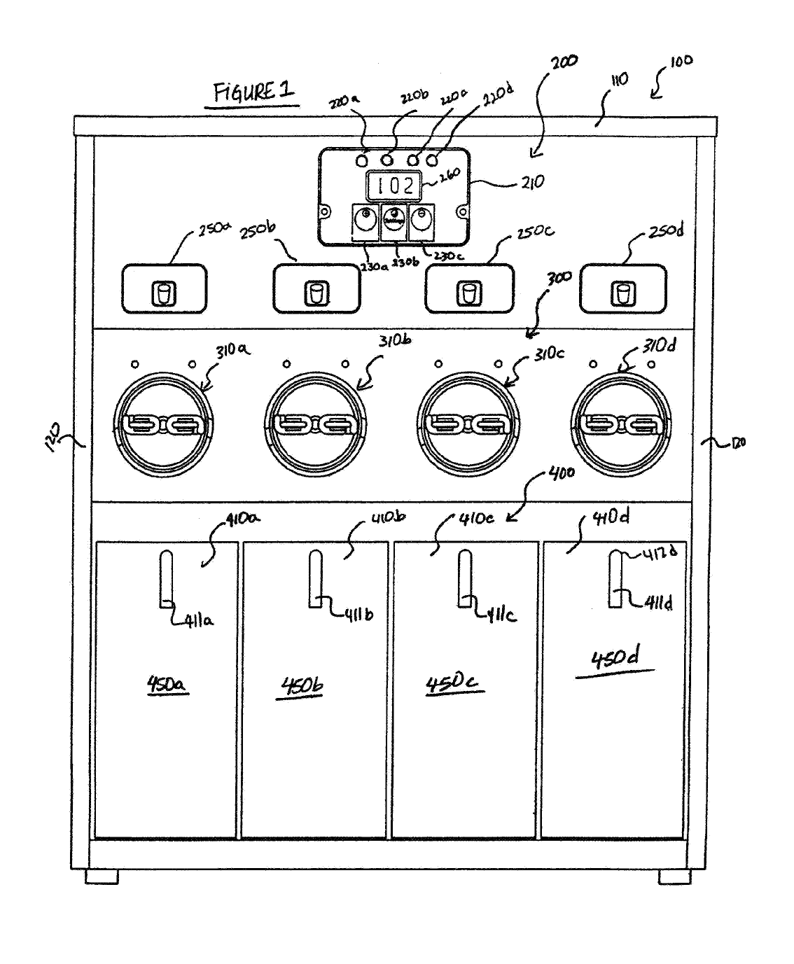

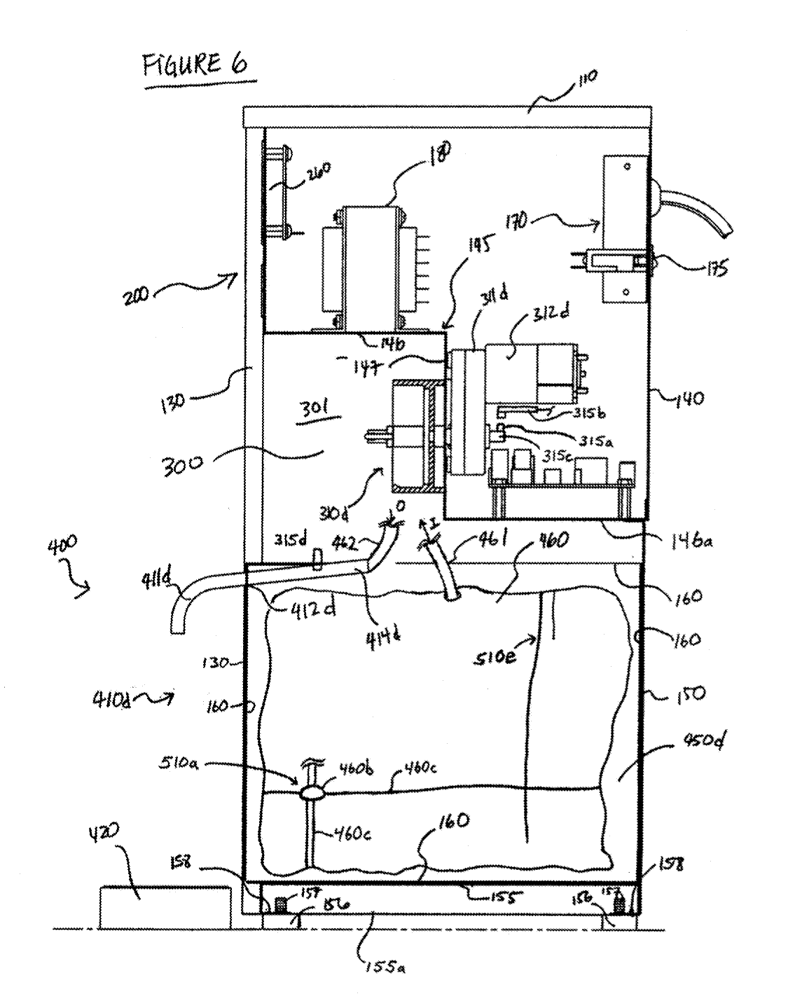

FIG. 1 illustrates a front view of one embodiment of the dispensing apparatus 100. The dispensing apparatus 100 comprises a user interface 200 disposed above a pumping station 300, a dispensing station 400, and a central controller 500 in communication with at least the user interface 200 and the pumping station 300. The user interface allows the user to engage with the dispensing apparatus by allowing the dispensing apparatus to record user information and to dispense the desired quantity of product, such as a developer solution. The user interface is in signal communication with a central controller 500 (FIG. 6), which provides for dispensing of the desired amount of developer solution.

As illustrated in FIGS. 1 and 6, the dispensing apparatus comprises an upper housing panel 110, side housing panels 120, and front housing panel 130, connected to at least one of an upper back frame 140, a lower back frame 150, and a bottom frame 155, wherein the housing panels 110, 120, 130, and frames 140, 150, 155 define an interior space of the dispensing apparatus.

The lower back frame 150 is connected to the bottom frame 155. The bottom frame 155 has two inner lips 158 through which bolts 157 extending from support legs 165 pass through. A nut (now shown) may be affixed to the bolt on the upper side of the inner lips to secure the beet to the frame. A frame panel 155a may enclosure the bottom of the interior space. A reservoir container 160 sits on the bottom frame 155 and between the back frame 150 and the front panel 130.

The dispensing apparatus uses a power supply to operate. Electrical current from an outlet is supplied to the dispensing apparatus at the power supply 170. The power supply 170 comprises a power supply switch 175 and a power regulator 180. The power switch which interrupts or connects the flow of current to a power regulator 180 such as a transformer. The power supply 170 and the switch 175 is mounted to the upper back frame. An internal frame structure 145 is a stepped shaped. The power regulator 180 is mounted to the top 146 of the step. The pump 310d is mounted to the side surface 147 of the step. The pump may alternatively be mounted on the lower step 146a.

This configuration allows for the electronic components of the dispensing apparatus to be above and away from the dispensing mechanism 410 which prevents unintentional contact between developer solution and electrical components. The configuration also allows for tubes connecting to the inlet and outlet of the pump 310d to be disposed in a region of space 301 disposed in front of the pump 310d to avoid over crowding of flexible tubes and allow for secure connection of tube ends. The dispensing station 400 is easily accessible for replenishment of empty developer reservoirs or containers.

### User Interface

The user interface 200 can incorporate a variety of features to correspond with the desired capabilities of the dispensing apparatus. As illustrated in FIG. 1, the user interface comprises a display panel 210 and a row of dispenser buttons 250. The display panel can have a number of indicator lights 220a, 220b, 220c, 220d corresponding to the number of dispensers within the dispensing apparatus. Four indicator lights 220a, 220b, 220c, 220d, as well as four dispenser buttons 250a, 250b, 250c, 250d, are illustrated, corresponding to the four dispensing mechanisms 410a, 410b, 410c, 410d respectively, within the dispensing station 400. In another embodiment, the user interface may comprise an interactive touch screen display as the input device of the apparatus and connected to the controller.

The display panel 210 further comprises touch buttons which can be used to display the status of each of the four dispensers. The touch button can be depressed to scroll through the status of each dispensing mechanism which is displayed on a display screen 260. In one embodiment, the first touch button 230a can be used to display (i) the level of developer left in the dispenser, (ii) whether a new container of developer is needed, or (iii) the number of times the developer solution has been replaced. As the touch button is repeatedly pressed, the display panel can scroll through and display the developer level information for each of the dispensing stations. The second and third touch buttons 230b, 230c can be used to display or select data. A user can scroll through the data with each press of the touch button 230b or 230c. Indicator lights communicate to the user which dispensing mechanism's information is being displayed. For example, indicator light 220a will be lit when information about the first dispensing mechanism is being displayed.

Alternately, the dispenser buttons 250a, 250b, 250c, 250d can be used to select the desired dispensing mechanism for which information is displayed on the screen 260. In one embodiment, a first press of the dispenser button can indicate to the controller 500 that information corresponding to the selected dispensing mechanism is desired. The user can then press a touch button 230a, 230b, 230c for the desired status of the selected dispensing mechanism rather than have to scroll to see the information pertaining to the selected dispensing mechanism.

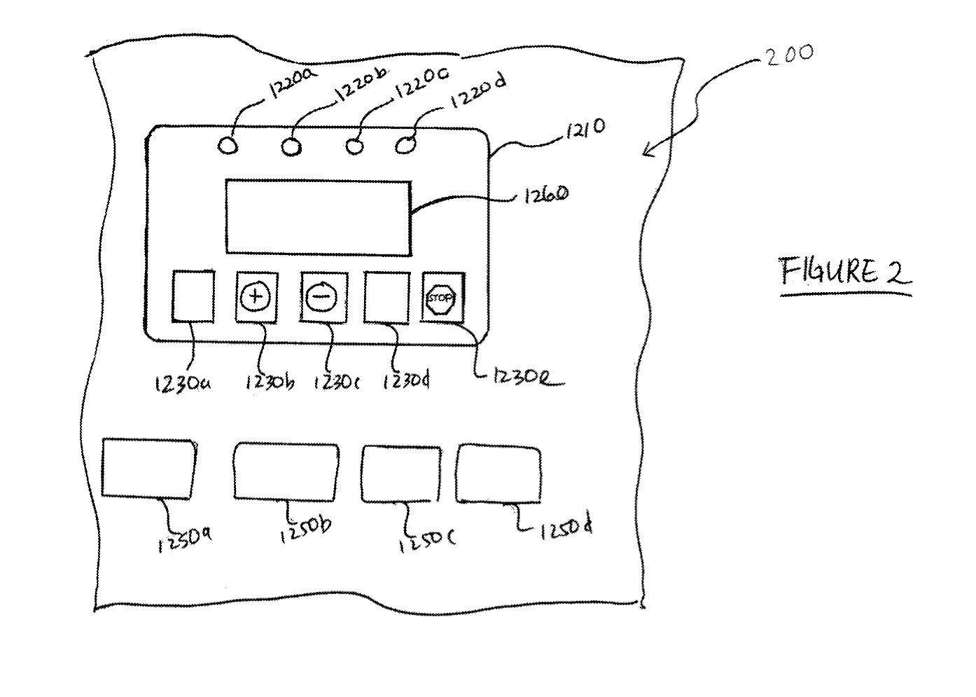

In another aspect, the touch buttons can be used to select or set desired settings by the user, rather than passively displaying desired information about each dispensing station. In one embodiment, illustrated in FIG. 2, a first touch button 1230a can be used to select a desired dispensing mechanism. Indicator lights 1220a, 1220b, 1220c, 1220d light up to communicate to the user which dispensing mechanism has been selected. Touch buttons 1230b, 1230c can be used to select the amount of developer to be dispensed by either adjusting a pre-set amount using the “+” or “−” button to arrive at the desired amount, or by using the “+” button to increase the amount of developer to the desired level. Once the correct amount of dispenser has been selected, a user can push a dispenser button 1250a, 1250b, 1250c, 1250d to dispense the desired amount of developer solution. In one embodiment, only one dispenser button may be necessary since selection of the desired dispenser can be communicated by pressing a touch button until the desired indicator light turns on. Alternately, rather than using a touch button and indicator light to select the desired dispensing mechanism to activate, the user can press one of the dispensing buttons 1250a, 1250b, 1250c, 1250d to activate and enter the desired parameters for the particular dispensing mechanism.

Touch button 1230d can be navigate to the user authentication prompt. Touch button 1230e may be used to select other relevant parameters, or can be a stop button which allows the user to pause or terminate the dispensing of developer product for example, in the event that the wrong amount of developer product was entered, or if it becomes evident that the container holding the hair dye treatment and developer is too small, or if the user desires to pause and mix the developer solution in increments.

Developer solution may be dispensed in several ways. In one embodiment, a user may depress a button, for example, one of dispensing buttons 1250a,1250b, 1250c, 1250d. The user depresses the button until the desired amount of developer solution has been dispensed. The display screen 1260 communicates to the user the amount of developer solution being dispensed. The user stops depressing the dispense button when the desired amount of developer, as displayed on the screen 1260, has been reached. Alternatively, an amount of developer solution may be pre-selected, and dispensed. In the event additional dispenser is desired beyond the pre-selected amount, the user may depress a button, such as a dispense button 1250a, or the “+” button 1230b to add additional dispenser in small predefined increments.

Alternately, indicator lights can be used to communicate to a user when the level of developer solution has fallen below a predetermined level, and is in need of replenishment. In one embodiment, the user enters the desired amount of developer solution to dispense. The controller calculates the amount of developer solution remaining in the dispensing mechanism, and indicates to the user whether there is sufficient developer solution to complete the dispensing process, or whether the developer solution is likely to run out and a back up solution should be readily available for replenishment. The advance notice of whether or not a container of back-up solution needs to be on stand-by for a quick switch of container solution during the dispensing of a certain amount of developer solution will assist the administrator in minimizing waste of developer solution by minimizing the time needed for replacing a new container solution during which time oxidation of the already dispensed developer solution will start to occur.

A sensor is used to determine the level of developer in the reservoir. A sensor may be located in each reservoir. The sensor may be any sensor known in the art that can be used to determine the level of fluid in a reservoir. FIG. 6 shows two type of possible product level sensors 510a, 510e. The sensors are shown in the alternative and therefore the apparatus is not required to have both. The first developer level sensor 510a uses a float 460b that moves along a shaft 460c. The float is connected to a rheostat (not shown), which passes an different rate of voltage depending on the height of the float. The controller calculates the amount of product in the reservoir by comparing the voltage provided by the rheostat to predefined values to determine the amount of product in the reservoir. Alternatively, the second product level sensor 510e may be that disclosed in U.S. Pat. No. 5,353,963.

Numerous other configurations for the user interface can be used.

### User Tracking

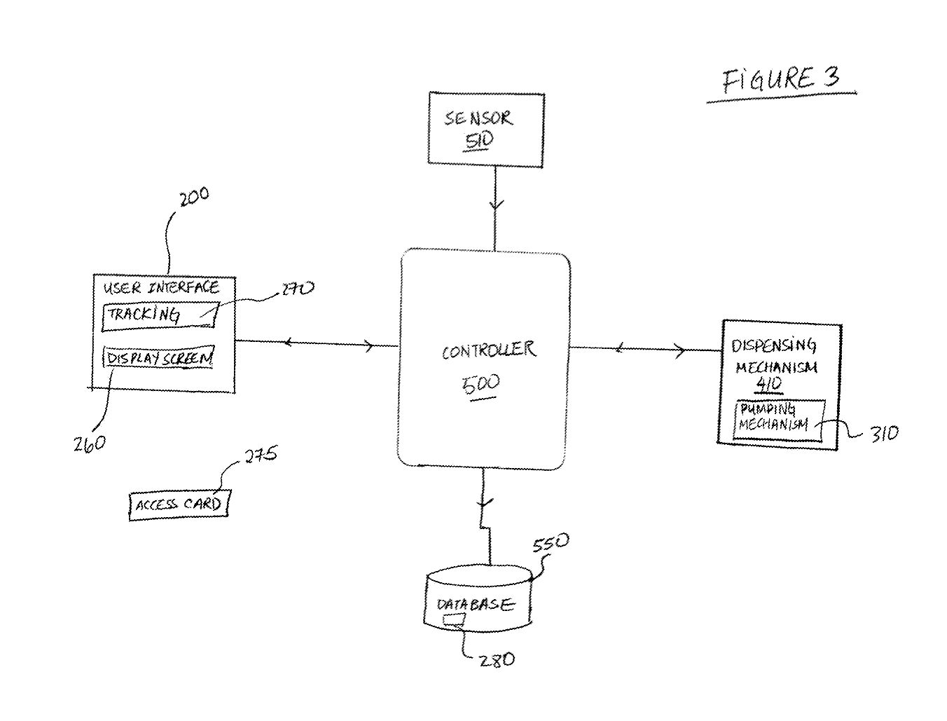

The user interface 200 further comprises a user tracking mechanism 270 schematically illustrated in FIG. 3. The tracking mechanism 270 is used to keep track of the amount of developer solution used by each user. The tracking mechanism may be of various types. In one embodiment, the user selects their name or other identifier from a list of users pre-programmed into the dispensing apparatus. The user list may be modified by users having increased rights, such as administrator users. The user may press a button, for example 1230d, to scroll through a list of users until the user's own name or other identifier is displayed. In alternate embodiments, the user is prompted to enter an input access code to indicate to the controller that any dispensed developer should be assigned to the user corresponding to the entered code. The user can enter an input access code manually by entering numbers on a key pad (not shown) on the user interface 200, or by scanning a key card over a card sensor (not shown) on the user interface 200, or by an radio frequency identification (RFID) arrangement, or by other known user authentication devices. The user can engage with the user tracking mechanism first to gain access various usage prompts to enter the desired amount of developer to be dispense, or alternatively, the user can engage with the various usage prompts and enter the user access code right before the dispense command is given. Alternatively, the user may insert an access card 275 into a slot or card reader to activate a series of user prompts. The access card 275 may have a unique identification number associated it with the card, and may be reformatted in the event the card is given to a new user. Other methods of automatically keeping track of the user's identity and the amount of developer use attributed to the user can be used.

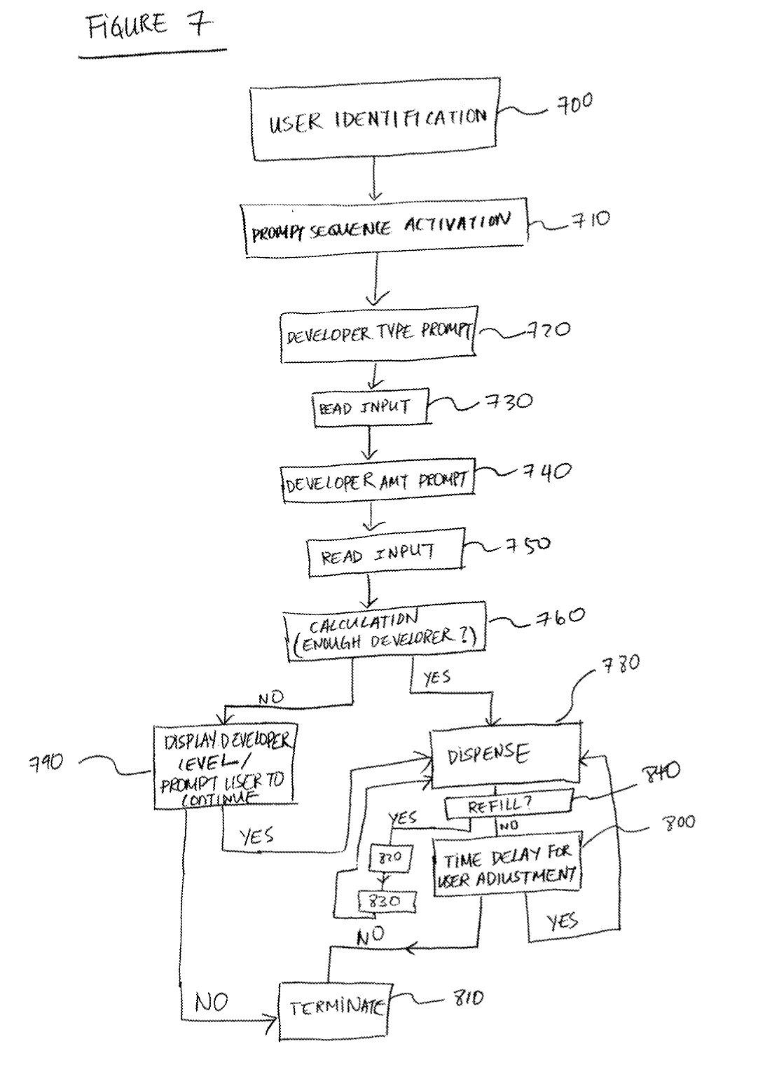

In one embodiment, the apparatus will not dispense product from the reservoir without a user being authenticated by an authentication procedure such as user identification at step 700 of FIG. 7. The authentication procedure prompts a user to provide authentication information. The user provides authentication information to the apparatus by user access code, user name and password, key card, RFID, or other authentication device. The database 550 has a user table or alternatively a user database is connected to the controller. The controller compares the user authentication information received from the user to the records in the user table or user database by known database lookup methods. If a user record matches the user provided authentication information the apparatus will dispense product or continue to operate at step 710 as described below. In this way all usage of the product in the reservoirs will be tracked by the apparatus.

### Usage Parameters

In addition to the amount of developer usage that is attributed to the user, the user tracking mechanism can be used to keep track of other usage parameters and display the data on the display screen. Other parameters which can also be kept track of include the type of developer used, and the time and date the developer was used. By keeping track of such parameters, an administrator being presented with usage parameter data can better pinpoint the usage dynamics of developer solution. For example, usage parameter data can be used to determine what time of developer solution is used most frequently during a certain time of the day, thus allowing better monitoring of developer solution to ensure that a steady supply is available on hand. Other usage parameters may include the number of times each user has refilled the dispenser container, or the type of hair dye being used with the developer. Such usage parameter data may be processed by the controller 500 and transferred to a database 550 for collection.

### Administrator Users

The controller maintains at least two type of users, an end user and an administrator user. The administrator user has additional rights over that of an end user. An administrator is able to (1) create new users, (2) modifying user account information, (3) modifying or rest user usage statistics, (4) review users usages, (5) transfer data from the apparatus to an external device, and (6) refill product in the reservoir. While the forgoing is a list of administrator activities, the device may comprise additional administrator activities. The device may comprise a physical lock that secures access to the interior of the apparatus. The lock may provide secure access through a key, key card, or access code. In one embodiment, the access code is entered via the user interface to release or secure the lock.

The system may have a reorder function. The reorder function allows an administrator to specify that when a particular reservoir is below a predefined level as reported by the sensor 510a or 510e, then a notice will be sent to the administrator or a person designated by the administrator. The notice may be sent via email or SMS or other mobile text message protocol provided that the apparatus is connected to the internet or to a device, which in turn is connected to the Internet or cellular network. The reorder function may be set to send a reorder notice automatically after a predefined number of refills have been made to a particular reservoir. The machine may have a refill data storage for recording how many times a reservoir is refilled. Therefore, a manager or administrator can set that the apparatus should send a reorder notice when, for example, 10 refills of a given reservoir have been made. This is helpful under an example scenario where the the reservoir holds one bottle of developer, the order quantity is 12 bottles, therefore when 10 bottles of developer have been used by the apparatus, the developer should be reordered because only 2 bottle are left. Further, the reorder function may connect to the internet or to a proprietary system and use an API to issue a reorder request directly to the supplier without requiring human intervention.

### Transferring Usage Parameter Data

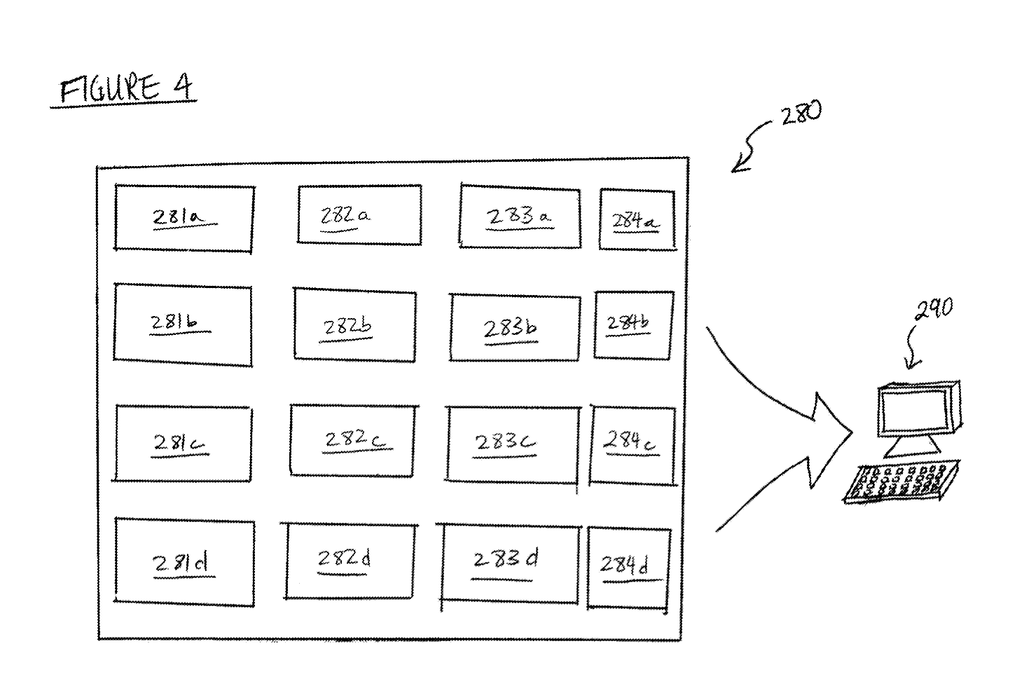

In one embodiment, the usage parameter data table 280 may be transferred or any other data retained and stored by the apparatus and downloaded for further processing as illustrated in FIG. 4. Before, any data transfer to an external device can occur, first a administrator user must be authenticated. Access to data transfer functions of the machine are restricted so that only a designated administrator may transfer data. The data 280 stored in the database 550 may be transferred via USB, wired, or wireless connection to a computer 290. This data allows for detailed monitoring and reporting of usage on each user.

The usage parameter data 280 can comprise, for example, a field for data on each individual user comprising user identifying information 281a, 281b, 281c, 281d for four users. However, it is understood that the apparatus is not limited to only 4 users, the apparatus may have as many users as the capacity of the database and memory storage will handle in a given implementation. The next column comprises a data field 282a, 282b, 282c, 282d to keep track of the type of developer solution used by each user 281a, 281b, 281c, 281d respectively. Additional fields 283a, 283b, 283c, 283d can contain information about the amount of developer used, while fields 284a, 284b, 284c, 284d can contain time and date information about the usage. Accordingly, the type and amount of each dispensing transaction is recorded, time stamped, and assignable to a user. This data may be used to allocate a cost of using the developer to each user. Therefore a business may accurately track the use of the developer and may assess a cost based on the amount of developer used by each user.

In one embodiment, the table of FIG. 4 has a user field 281, a developer type field 282, an amount dispensed field 283, and a date and time dispensed field 284. For each dispensing event, a record is created in the table. A record comprises one field from each of of the columns 281, 282, 283, 284. In one example, when a dispensing event occurs, the user dispensing the product is recorded in field cell 281a, the type of product is recorded in cell 282a, the amount of product dispensed is recorded in cell 283a, the date and time of the dispensing event is recorded in cell 284a.

Other aspects of the dispenser use, such as when the dispensing system was cleaned, when the developer solution is replaced, can also be monitored. Such data can be recorded in a maintenance database. Warning lights can be activated to indicate low levels of developer solution, or can be activated when the dispensing apparatus needs to be maintained or cleaned. In addition or in the alternative, any alert may be communicated to an administrator or a person, email address, or text message recipient designated collectively or separately for each type of alert.

The recording of various parameters allows reports to be generated on different aspects of the business, such as the most profitable employees, or the frequency of use of particular developer solutions, over a particular time period such as quarterly or yearly. Generating reports to illustrate data can also assist in identifying coloring trends during the year, or productivity of employees as a function of time.

It is understood that the foregoing is one way of recording the data needed for the apparatus to operate according to the features described herein, other methods known to one skilled in the art for carrying out these features within a computer, controller, or computer readable medium are encompassed within the invention.

### Dispensing Station

The dispensing station 400 comprises a dispensing mechanism 410a, 410b, 410c, 410d which includes a nozzle 411a, 411b, 411c, 411d, respectively. As illustrated in FIG. 1, the dispensing apparatus 100 has four dispensing mechanisms. FIG. 6 illustrates a side view of the dispensing apparatus which shows only dispensing mechanism 410d.

Dispensing mechanism 410d will be described, dispensing mechanisms 410a, 410b, 410c are identical to that of 410d. Dispensing mechanism 410d comprises a dispensing nozzle 411d which extends from the interior of the dispensing apparatus to the exterior of the dispensing apparatus through an opening 412d in the product compartment 450d. The product compartment 450d is an area of spaced suitable for receiving the product, for example, developer solution.

The developer solution may be contained in a reservoir or container such as a plastic bottle, a collapsible membrane such as a plastic bag, a cartridge, or any other sealed container that is capable of holding a liquid. In another embodiment, the reservoir is a fixed sized container such as reservoir container 160. The reservoir can be any shape. As illustrated in FIG. 6, the reservoir is a flexible bag 460. The reservoir 460 can comprise a dispensing port 461 which allows the contents of the reservoir to be in communication with other dispensing components, such as a pump 310d. The dispensing port 461 can be a flexible tube which is connected to an inlet of a pump 301d. The reservoir that contains the developer solution is sealed so that the developer is not exposed to the air. This avoids oxidization of the developer, which promotes more consistency in the resulting hair color because the developer is less likely to oxidize. The dispensing apparatus also insures the proper amount of developer is dispensed and thereby ensures the proper ratio of color to developer is used by the user each time to promote consistency between customer visits.

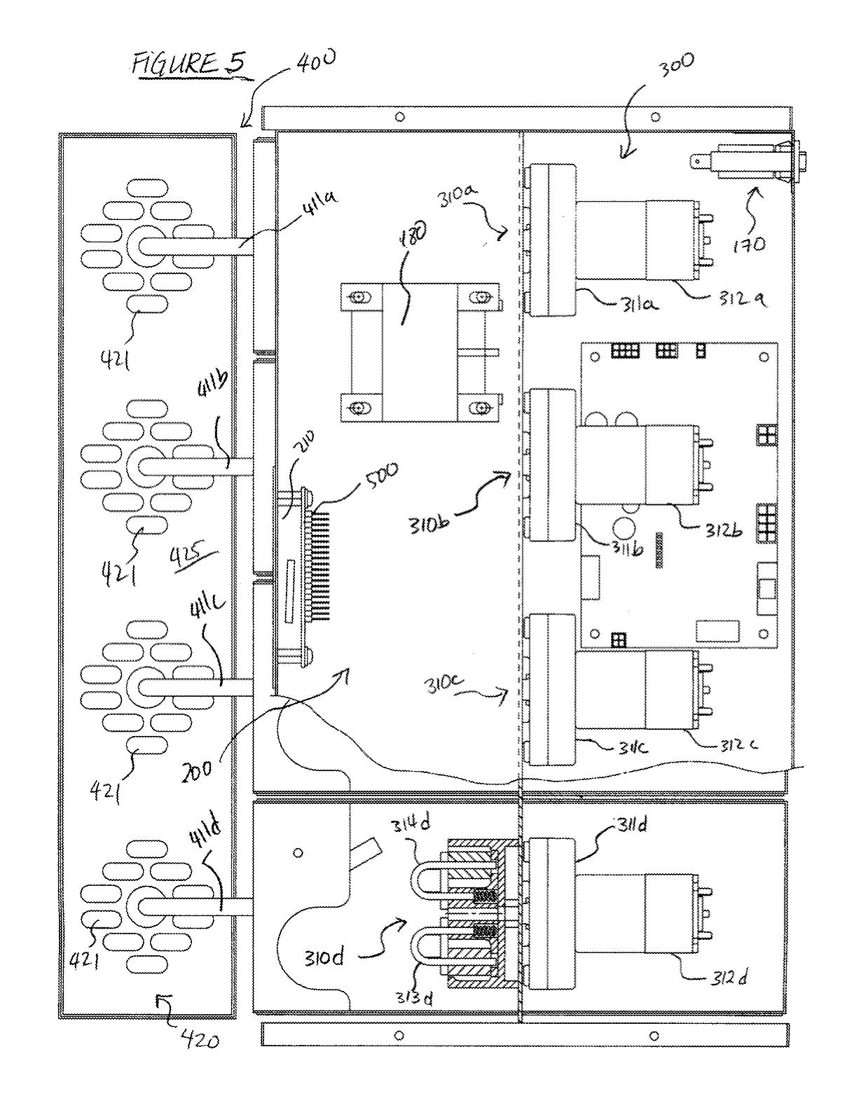

The dispensing station 400 further comprises a drip tray 420 (FIGS. 5 and 6) to receive any overflow of developer solution or to capture any developer solution that may incidentally drip from the nozzle. The drip tray consists of a ledge 425 with perforations 421 below each nozzle 411a, 411b, 411c, 411d to allow excess developer solution to be captured within the tray 420.

To access the compartment 450d for refill of the developer solution, the housing panels surrounding the compartment, as well as other dispenser apparatus components are removable. Housing panels can be removed in one unitary component such that all components of the dispensing apparatus is accessed simultaneously. Alternatively, housing panels may be removable independent of other housing panels, such that access to particular areas of the dispensing apparatus, such as the compartment 450d for refilling the container, can be granted without exposing the other components of the dispensing apparatus. In one embodiment, the front panel is removed to access the compartment 450d.

The housing can be made of various materials. Preferably the housing is made of material which is inert and can withstand contact with developer solution, hair dye treatments, and other chemicals present in a hair salon. The housing material can be made from metallic elements, ceramics, polymeric materials, or a combination thereof. The housing material can be made from polymeric materials, such as polyethylene, polypropylene, polystyrene, acrylonitrile butadiene styrene, resins, or a combination thereof.

### Pumping Station

The pumping station 300 comprises a row of pumps 310a, 310b, 310c, 310d disposed below the user interface 200 and above the dispensing station 400. Other arrangements are possible. The apparatus can be configured with any number of pumps and corresponding reservoirs.

As illustrated in FIG. 1, each pump is disposed above each dispensing mechanism for a pump to dispensing mechanism ratio of 1:1. Each pump is responsible for dispensing the developer solution in the compartment located beneath the pump. As illustrated in FIG. 5, the pump 310a, 310b, 310c, 310d comprises a pumping mechanism 311a, 311b, 311c, 311d which is operated by a corresponding pump motor 312a, 312b, 312c, 312d. The pumping mechanism 311a, 311b, 311c, 311d may be a reciprocating piston pump, a peristaltic pump, or any other suitable pumping mechanism known to one skilled in the art. In one embodiment the pumps 310a-310d are of the type and design shown and described in U.S. Pat. No. 5,353,963 and labeled as concentrate pump 20 therein. U.S. Pat. No. 5,353,963 is herein incorporated by referenced to the extent on inconsistent with the present description.

The pump 310d is illustrated in FIGS. 5 and 6. All other pumps operate in a similar fashion. The dispensing port 461 of the container 460 is connected to the inlet of the pump such that fluid in the container 460 is in communication with the inlet. The internal end 414d of the dispensing nozzle 411d is connected via a flexible tube 460 to the outlet of the pump 310d such that fluid exiting the pump outlet is transferred into the dispensing nozzle 411d to be dispensed.

The system have a prime function for priming the system when the system is empty or when a reservoir is refilled. A prime function will eliminate air from the system between the reservoir to the outlet of the pump or the dispensing nozzle. In this way, the amount dispensed can be accurate when the measurement of the amount dispensed depends on measuring the rotations of the output shaft of the pump.

The amount of developer solution dispensed can be kept track of by signal communication between the pump and the controller. A sensor may be mounted within or outside of the pump to track the movement of the pump. For example, pump rotation sensor 315 is placed to read sensor read marker 315a that is mounted to the the back end of the output shaft of the pump 315c. The sensor is signal connected to the controller. Other sensor arrangements are also possible. The senor can determine how far the pump output shaft has rotated. Given that a predefined amount of product will be dispensed based on a predefined amount of rotation of the pump, the controller can calculate and control the amount of product dispensed by the pump. Also, depending on the type of pumping mechanism used, the amount of developer solution dispensed can be calculated by, for example, the amount of time the pump is pumping if flow rate is know, or by the amount of liquid pushed out with each rotation of a peristaltic pump mechanism.

In another embodiment, the amount of product dispensed is determined by information received from a flow sensor 315d that is signal connected to the controller. The flow sensor is placed in the internal end portion of the dispensing nozzle 414d to measure the amount of product that passes the sensor. In another embodiment the flow sensor is placed at the output of the pump.

### Central Controller

The central controller 500 controls the operation of and coordination of the various components of the dispensing apparatus 100. In operation, a user uses the user interface 200 to engage with the dispensing apparatus. In one embodiment, as shown in FIG. 7, the user activates user prompts by entering identifying information at step 700 using an user tracking mechanism 270. The user tracking mechanism may include entering an access code on a key pad, scanning a user access card 275, or swiping or inserting the access card 275 through a card reading slot, or another known method for authenticating a user with electronics or computers. Once the user enters identifying information, the user uses touch buttons and display screen communication to communicate the desired developer to be dispensed by the dispensing apparatus. Dispense event information is sent to the controller which transmits the information entered, along with other information such as time of the transaction, into a dispense event datastore or database 550. The datastore may be a database, a table in a database, a text file, a spreadsheet, or other methods or devices of holding electronic information. Database 550 comprises the dispense event information or usage parameter data table 280. Information pertaining to the desired dispensing transaction is transmitted to the dispensing mechanism at step 600. A sensor 510 can be used to determine the level of developer solution remaining in the developer container and to trigger an alert when the level of developer solution has fallen below a pre-determined level. The sensor 510 shown in FIG. 3 may comprise sensor 510a or 510e. Alternatively, the level of developer solution remaining in the developer container can be determined by keeping track of the amount of developer solution that has been pumped out by the dispensing mechanism in relation to the known full value.

FIG. 7 illustrates the logic steps of one embodiment of the system processing.

After the user identification step 700, the prompt sequence is activated at step 710. The user is prompted to by the developer type prompt step 720 and developer amount prompts at step 740 to enter in the information. The controller reads the input at steps 730, 750 after information is entered. The controller calculates, at step 760, whether or not sufficient developer remains in the developer container. A sufficient developer amount can be programmed to take into consideration any user adjustments which may occur. A buffer amount can be added to the calculation of whether or not there is sufficient developer. For example, a user may select a pre-determined amount of developer to dispense, but may add a bit more manually after the pre-determined amount of developer solution is dispensed. This manual addition of developer solution is the “user adjustment” volume, which can be combined with the pre-determined amount of developer solution to determine whether sufficient volume of developer solution remains. The user adjustment volume may be pre-set to a value reflecting typical user adjustment volumes for developer solutions in general, or may be specific to a developer solution type, or the controller may keep track of user specific adjustment volumes for each particular developer solution.

If it is determined that enough developer is present in the developer container, the system proceeds to dispense the developer at step 780. If it is determined that not enough developer is present in the developer container, the level remaining is displayed and the user asked whether to continue. During this time, the user may select to notify an administrator to retrieve a refill container of developer solution, or the user may choose not to continue. If the user elects to discontinue at that time, the system terminates 810 and returns to the user authentication step 700. If the user chooses to continue, the system proceeds to dispense at step 780. As the system dispenses, the level of developer solution is monitored, at step 840, to determine whether a refill is needed.

If a refill is not needed, the system finishes dispensing developer solution according to the pre-selected amount and waits for a preselected interval to see if the user opts to adjust the amount dispensed by adding more. Once the user has finished adjusting the amount of developer solution, the system terminates its sequence 810 and returns to the user authentication step 700.

If a refill is needed, the need for refill is displayed, at step 820 on a screen to communicate with the user, and prompts the user to provide an input, at step 830 to continue with dispensing at step 780 once the user has completed the refill process.

Numerous other logic steps can be used to actuate other embodiments of system processing or carry out the functions and features of the apparatus described hererin. For example, in other processing steps, the user identification step may come at a later steps, such as right before dispensing, and is not needed to activate the prompt sequence.

In one embodiment, the controller 500 may be implemented as a programmed general purpose computer, or a single special purpose integrated circuit (e.g., ASIC) having a main or central processor section for overall, system-level control, and separate sections dedicated to performing various different specific computations, functions and other processes under control of the central processor section. In another embodiment, the controller is a plurality of separate dedicated or programmable integrated or other electronic circuits or devices. In another embodiment the controller is a programmed general purpose computer, such as one having a microprocessor, microcontroller or other processor device (CPU or MPU), either alone or in conjunction with one or more peripheral data and signal processing devices. In general, any device or assembly of devices on which a finite state machine capable of implementing the procedures described herein can be the controller.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A hair product dispenser, comprising:
at least one hair product reservoir;
a pump connected to the reservoir;
a dispensing nozzle connected to the pump;
a user input device;
a dispense event datastore; and
a controller configured to control the operation of the dispenser, the controller is signal connected to the pump, the dispense event datastore, and to the user input device.

2. The dispenser of claim 1, wherein the controller has a user authentication function comprising:
authentication compare instructions configured to compare user authentication information supplied from the input device to a user information datastore;
authentication approval instruction configured to provide access to a dispense function when user authentication information is matched to a user record in the user information database by the authentication compare instructions.

3. The dispenser of claim 2, wherein the controller has a dispense control function that prevents the dispenser from dispensing product if a user is not authenticated by the user authentication function.

4. The dispenser of claim 1, wherein the controller has a dispense function comprising dispense instructions configured to signal to the pump to dispense a predefined product dispense amount of product.

5. The dispenser of claim 1, wherein the controller has a record function comprising record dispense event instructions configured to record dispense event information in a dispense event datastore.

6. The dispenser of claim 5, wherein the dispense event information comprises user identification information and amount dispensed information.

7. The dispenser of claim 6, wherein the dispense event information comprises product-type information of the product dispensed.

8. The dispenser of claim 6, wherein the dispense event information comprises time-stamp information when the product was dispensed.

9. The dispenser of claim 1, wherein the controller has an adjust dispense amount function comprising adjust instruction configured to set the product dispense amount.

10. The dispenser of claim 1, wherein the controller has external transfer function comprising transfer instructions configured to send dispense event information to an external device.

11. The dispenser of claim 1, comprising a product sensor signal connected to the controller and configured to report a level of product in the reservoir.

12. The dispenser of claim 11, wherein the controller has a low product notice function comprising notice instructions configured to send notification that the reservoir is low to a predefined electronic address when the product sensor signals the level of product in the reservoir is below a predefined minimum value.

13. The dispenser of claim 1, comprising an external transfer device connected to the controller and configured to transfer information from the dispenser to an external device as directed by the controller.

14. A method of dispensing hair products from a dispensing machine, comprising the steps of:
authenticating user authentication information provided by a user against a user information datastore;
dispensing a predefined dispense amount of product from the dispensing machine if the user authentication information is authenticated;
recording dispense event information in a dispense event information datastore.

15. The method of claim 14, comprising the step of, before dispensing, setting the dispense amount of product.

16. The method of claim 14, comprising the step of recording dispense event information comprises the steps of: recording user identification information and amount dispensed information for the dispense event.

17. The method of claim 14, wherein the step of recording dispense event information comprises the step of recording user identification information and amount dispensed information of the dispense event.

18. The method of claim 14, wherein the step of recording dispense event information comprises the step of recording product-type information of the product dispensed during the dispense event.

19. The method of claim 14, comprising the step of transferring information from the event information datastore to an external device.

20. A hair color product dispenser, comprising:
at least one hair product reservoir;
a pump connected to the reservoir;
a dispensing nozzle operatively connected to the pump;
a user input device;
a controller signal connected to the pump, the dispense event datastore, and to the user input device; the controller has a dispense control function that prevents the pump from dispensing product unless authenticated user authentication information is received from the user input device.
